(19) United States
(12) Patent Application Publication
(10) Pub. No.: US 2026/0077948 A1
(43) Pub. Date: Mar. 19, 2026

(54) SYSTEM AND METHOD FOR REARRANGING CONTAINERS IN AN AUTOMATED STORAGE AND RETRIEVAL SYSTEM

(71) Applicant: AutoStore Technology AS, Nedre Vats (NO)

(72) Inventor: Rune Brattbakk Bilit, Asker (NO)

(21) Appl. No.: 19/106,241

(22) PCT Filed: Aug. 29, 2023
(86) PCT No.: PCT/EP2023/073713

§ 371 Date: Feb. 25, 2025

(30) Foreign Application Priority Data
Sep. 1, 2022 (NO) 20220940

(51) Int. Cl. B65G 1/137; B65G 1/04; G06F 9/48

(52) U.S. Cl. CPC B65G 1/1371; B65G 1/0464; B65G 1/1378; G06F 9/4881

(57) ABSTRACT

A method and system for rearranging containers in a storage and retrieval system comprising a three-dimensional storage grid structure for storing items. The grid structure forms vertical storage columns each having a horizontal area defined by the size of an access opening of the vertical storage columns. The framework structure comprises a rail system arranged above the storage columns. The method comprises checking if there are free spaces along at least one of the edges of the grid of the storage and retrieval system, checking if there are enough free spaces in the non-edge cells of the grid of the storage and retrieval system to perform normal operations, and performing rearranging if there are free spaces along at least one of the edges of the grid of the storage and retrieval system and there is not enough free spaces in the non-edge cells of the grid of the storage and retrieval system to perform normal operations.

### FIELD OF THE INVENTION

The present invention relates to an automated storage and retrieval system for storage and retrieval of containers, in particular to a system and method for distributing the containers evenly around the grid in order to prevent the edges from having to many vacant spaces in the stacks of containers.

### BACKGROUND AND PRIOR ART

FIG. 1 discloses a prior art automated storage and retrieval system 1 with a framework structure 100 and FIGS. 2, 3 and 4 disclose three different prior art container handling vehicles 201, 301, 401 suitable for operating on such a system 1.

The framework structure 100 comprises upright members 102 and a storage volume comprising storage columns 105 arranged in rows between the upright members 102. In these storage columns 105 storage containers 106, also known as containers, are stacked one on top of one another to form stacks 107. The members 102 may typically be made of metal, e.g. extruded aluminum profiles.

The framework structure 100 of the automated storage and retrieval system 1 comprises a rail system 108 arranged across the top of framework structure 100, on which rail system 108 a plurality of container handling vehicles 201, 301, 401 may be operated to raise storage containers 106 from, and lower storage containers 106 into, the storage columns 105, and also to transport the storage containers 106 above the storage columns 105. The rail system 108 comprises a first set of parallel rails 110 arranged to guide movement of the container handling vehicles 201, 301, 401 in a first direction X across the top of the frame structure 100, and a second set of parallel rails 111 arranged perpendicular to the first set of rails 110 to guide movement of the container handling vehicles 201, 301, 401 in a second direction Y which is perpendicular to the first direction X. Containers 106 stored in the columns 105 are accessed by the container handling vehicles 201, 301, 401 through access openings 112 in the rail system 108. The container handling vehicles 201, 301, 401 can move laterally above the storage columns 105, i.e. in a plane which is parallel to the horizontal X-Y plane.

The upright members 102 of the framework structure 100 may be used to guide the storage containers during raising of the containers out from and lowering of the containers into the columns 105. The stacks 107 of containers 106 are typically self-supporting.

Each prior art container handling vehicle 201, 301, 401 comprises a vehicle body 201a, 301a, 401a and first and second sets of wheels 201b, 201c, 301b, 301c, 401b, 401c which enable the lateral movement of the container handling vehicles 201, 301, 401 in the X direction and in the Y direction, respectively. In FIGS. 2, 3 and 4 two wheels in each set are fully visible. The first set of wheels 201b, 301b, 401b is arranged to engage with two adjacent rails of the first set 110 of rails, and the second set of wheels 201c, 301c, 401c is arranged to engage with two adjacent rails of the second set 111 of rails. At least one of the sets of wheels 201b, 201c, 301b, 301c, 401b, 401c can be lifted and lowered, so that the first set of wheels 201b, 301b, 401b and/or the second set of wheels 201c, 301c, 401c can be engaged with the respective set of rails 110, 111 at any one time.

Each prior art container handling vehicle 201, 301, 401 also comprises a lifting device for vertical transportation of storage containers 106, e.g. raising a storage container 106 from, and lowering a storage container 106 into, a storage column 105. The lifting device comprises one or more gripping/engaging devices which are adapted to engage a storage container 106, and which gripping/engaging devices can be lowered from the vehicle 201, 301, 401 so that the position of the gripping/engaging devices with respect to the vehicle 201, 301, 401 can be adjusted in a third direction Z which is orthogonal the first direction X and the second direction Y. Parts of the gripping device of the container handling vehicles 301, 401 are shown in FIGS. 3 and 4 indicated with reference number 304, 404. The gripping device of the container handling device 201 is located within the vehicle body 201a in FIG. 2 and is thus not shown.

Conventionally, and also for the purpose of this application, Z=1 identifies the uppermost layer available for storage containers below the rails 110, 111, i.e. the layer immediately below the rail system 108, Z=2 the second layer below the rail system 108, Z=3 the third layer etc. In the exemplary prior art disclosed in FIG. 1, Z=8 identifies the lowermost, bottom layer of storage containers. Similarly, X=1 . . . n and Y=1 . . . n identifies the position of each storage column 105 in the horizontal plane. Consequently, as an example, and using the Cartesian coordinate system X, Y, Z indicated in FIG. 1, the storage container identified as 106′in FIG. 1 can be said to occupy storage position X=17, Y=1, Z=6. The container handling vehicles 201, 301, 401 can be said to travel in layer Z=0, and each storage column 105 can be identified by its X and Y coordinates. Thus, the storage containers shown in FIG. 1 extending above the rail system 108 are also said to be arranged in layer Z=0.

The storage volume of the framework structure 100 has often been referred to as a grid 104, where the possible storage positions within this grid are referred to as storage cells. Each storage column may be identified by a position in an X- and Y-direction, while each storage cell may be identified by a container number in the X-, Y- and Z-direction.

Each prior art container handling vehicle 201, 301, 401 comprises a storage compartment or space for receiving and stowing a storage container 106 when transporting the storage container 106 across the rail system 108. The storage space may comprise a cavity arranged internally within the vehicle body 201a, 401a as shown in FIGS. 2 and 4 and as described in e.g. WO2015/193278A1 and WO2019/206487A1, the contents of which are incorporated herein by reference.

FIG. 3 shows an alternative configuration of a container handling vehicle 301 with a cantilever construction. Such a vehicle is described in detail in e.g. NO317366, the contents of which are also incorporated herein by reference.

The cavity container handling vehicle 201 shown in FIG. 2 may have a footprint that covers an area with dimensions in the X and Y directions which is generally equal to the lateral extent of a storage column 105, e.g. as is described in WO2015/193278A1, the contents of which are incorporated herein by reference. The term ‘lateral’used herein may mean ‘horizontal’.

Alternatively, the cavity container handling vehicles 401 may have a footprint which is larger than the lateral area defined by a storage column 105 as shown in FIGS. 1 and 4, e.g. as is disclosed in WO2014/090684A1 or WO2019/206487A1.

The rail system 108 typically comprises rails with grooves in which the wheels of the vehicles run. Alternatively, the rails may comprise upwardly protruding elements, where the wheels of the vehicles comprise flanges to prevent derailing. These grooves and upwardly protruding elements are collectively known as tracks. Each rail may comprise one track, or each rail 110, 111 may comprise two parallel tracks. In other rail systems 108, each rail in one direction (e.g. an X direction) may comprise one track and each rail in the other, perpendicular direction (e.g. a Y direction) may comprise two tracks. Each rail 110, 111 may also comprise two track members that are fastened together, each track member providing one of a pair of tracks provided by each rail.

WO2018/146304A1, the contents of which are incorporated herein by reference, illustrates a typical configuration of rail system 108 comprising rails and parallel tracks in both X and Y directions.

In the framework structure 100, a majority of the columns 105 are storage columns 105, i.e. columns 105 where storage containers 106 are stored in stacks 107. However, some columns 105 may have other purposes. In FIG. 1, columns 119 and 120 are such special-purpose columns used by the container handling vehicles 201, 301, 401 to drop off and/or pick up storage containers 106 so that they can be transported to an access station (not shown) where the storage containers 106 can be accessed from outside of the framework structure 100 or transferred out of or into the framework structure 100. Within the art, such a location is normally referred to as a ‘port’ and the column in which the port is located may be referred to as a ‘port column’ 119, 120. The transportation to the access station may be in any direction, that is horizontal, tilted and/or vertical. For example, the storage containers 106 may be placed in a random or dedicated column 105 within the framework structure 100, then picked up by any container handling vehicle and transported to a port column 119, 120 for further transportation to an access station. The transportation from the port to the access station may require movement along various different directions, by means such as delivery vehicles, trolleys or other transportation lines. Note that the term ‘tilted’ means transportation of storage containers 106 having a general transportation orientation somewhere between horizontal and vertical.

In FIG. 1, the first port column 119 may for example be a dedicated drop-off port column where the container handling vehicles 201, 301, 401 can drop off storage containers 106 to be transported to an access or a transfer station, and the second port column 120 may be a dedicated pick-up port column where the container handling vehicles 201, 301, 401 can pick up storage containers 106 that have been transported from an access or a transfer station.

The access station may typically be a picking or a stocking station where product items are removed from or positioned into the storage containers 106. In a picking or a stocking station, the storage containers 106 are normally not removed from the automated storage and retrieval system 1, but are returned into the framework structure 100 again once accessed. A port can also be used for transferring storage containers to another storage facility (e.g. to another framework structure or to another automated storage and retrieval system), to a transport vehicle (e.g. a train or a lorry), or to a production facility.

A conveyor system comprising conveyors is normally employed to transport the storage containers between the port columns 119, 120 and the access station.

If the port columns 119, 120 and the access station are located at different levels, the conveyor system may comprise a lift device with a vertical component for transporting the storage containers 106 vertically between the port column 119, 120 and the access station.

The conveyor system may be arranged to transfer storage containers 106 between different framework structures, e.g. as is described in WO2014/075937A1, the contents of which are incorporated herein by reference.

When a storage container 106 stored in one of the columns 105 disclosed in FIG. 1 is to be accessed, one of the container handling vehicles 201, 301, 401 is instructed to retrieve the target storage container 106 from its position and transport it to the drop-off port column 119. This operation involves moving the container handling vehicle 201, 301, 401 to a location above the storage column 105 in which the target storage container 106 is positioned, retrieving the storage container 106 from the storage column 105 using the container handling vehicle's 201, 301, 401 lifting device (not shown), and transporting the storage container 106 to the drop-off port column 119. If the target storage container 106 is located deep within a stack 107, i.e. with one or a plurality of other storage containers 106 positioned above the target storage container 106, the operation also involves temporarily moving the above-positioned storage containers prior to lifting the target storage container 106 from the storage column 105. This step, which is sometimes referred to as “digging” within the art, may be performed with the same container handling vehicle that is subsequently used for transporting the target storage container to the drop-off port column 119, or with one or a plurality of other cooperating container handling vehicles. Alternatively, or in addition, the automated storage and retrieval system 1 may have container handling vehicles 201, 301, 401 specifically dedicated to the task of temporarily removing storage containers 106 from a storage column 105. Once the target storage container 106 has been removed from the storage column 105, the temporarily removed storage containers 106 can be repositioned into the original storage column 105. However, the removed storage containers 106 may alternatively be relocated to other storage columns 105.

When a storage container 106 is to be stored in one of the columns 105, one of the container handling vehicles 201, 301, 401 is instructed to pick up the storage container 106 from the pick-up port column 120 and transport it to a location above the storage column 105 where it is to be stored. After any storage containers 106 positioned at or above the target position within the stack 107 have been removed, the container handling vehicle 201, 301, 401 positions the storage container 106 at the desired position. The removed storage containers 106 may then be lowered back into the storage column 105, or relocated to other storage columns 105.

For monitoring and controlling the automated storage and retrieval system 1, e.g. monitoring and controlling the location of respective storage containers 106 within the framework structure 100, the content of each storage container 106, and the movement of the container handling vehicles 201, 301, 401 so that a desired storage container 106 can be delivered to the desired location at the desired time without the container handling vehicles 201, 301, 401 colliding with each other, the automated storage and retrieval system 1 comprises a control system 500 which typically is computerized and which typically comprises a database for keeping track of the storage containers 106.

Ordinary storage and retrieval systems sometimes have a problem with holes in the grid being concentrated at the edges of the storage and retrieval grid. By a “hole” we refer to a cell that has at least one available space for an additional container. A “deep hole” typically refers to a cell with multiple free spaces. One of the tasks of the Router software is to keep the holes spread throughout the grid, as these free spaces are used for temporarily storing other containers during digging and preparation before being sent to port. The main way to level the grid (spread the holes) is done by placing containers strategically when coming out of a port. However, if all ports are on one side (south or north) of the grid, no containers will be put on the opposite side of the grid using this strategy. This typically results in relatively deep holes on the opposite side of the grid.

### SUMMARY OF THE INVENTION

The present invention is set forth and characterized in the independent claims, while the dependent claims describe other characteristics of the invention.

In one aspect, the invention is related to method for rearranging containers in an automated storage and retrieval system comprising a framework structure (100) forming a three-dimensional storage grid structure (104) for storing storage containers (106), where the framework structure (100) forms vertical storage columns (105) each having a horizontal area defined by the size of an access opening (112) of the vertical storage columns (105) and where the framework structure comprises a rail system (108) arranged above the storage columns (105), the rail system comprising a plurality of rails extending in an X-direction and a plurality of rails extending in a Y-direction to form a grid, the rails defining a perimeter of each access opening (112) on top of each storage column (105), the rail system (108) providing available routes in the X-direction or the Y-direction for container handling vehicles (201, 301) handling and transferring the storage containers (106) to and from the storage columns (105), wherein the method comprises monitoring the number of free spaces along at least one of the edges of the grid of the storage and retrieval system using a central computer system to determine if there are enough free spaces in a remainder of the cells of the grid of the storage and retrieval system to perform normal operations, creating one or more rearranging jobs in the central computer system if there are more than a predetermined density of free spaces along at least one of the edges of the grid of the storage and retrieval system and it is determined that the density of free cells is not enough in the remainder of the cells of the grid of the storage and retrieval system to maintain normal operations, instructing at least one container handling vehicle to perform the at least one rearranging job, wherein the at least one container handling vehicle transports containers to at least one of the edges of the grid from cells in the remainder of the grid of the storage and retrieval system.

Further, normal operations on the grid of the storage and retrieval system may continue after the at least one container handling vehicle has performed the at least one rearranging job, wherein a normal operation comprises performing a deep dig down for a container, or a normal operation requires the grid to have enough free spaces to place containers returning from a port.

Also, the central computer system can search for a target cell along at least one of the edges of the grid and it can search for a source cell from the remainder of the grid for each rearranging job, and it can search for a source container from the source cell. The central computer system can choose the target cell and the source cell based on the number of free spaces and/or available containers in the target cells and the source cells or the central computer system can choose a cell along at least one of the edges of the grid of the storage and retrieval system that has the largest number of free spaces to be the target cell.

The central computer system can choose a cell from the remainder of the cells that has the fewest free spaces to be the source cell.

The numbers of free spaces in neighbouring cells can be taken into account when picking the target cell and the source cell and when picking a source container.

Alternatively, the central computer system can choose a cell to be the target cell if that target cell and its neighbouring cells have the largest numbers of free spaces in a given area of the grid.

The central computer system can choose a cell to be the source cell if that source cell and its neighbouring cells have the fewest number of free spaces in a given area of the grid.

Also, the central computer system can choose a container to be a source container based upon the number of times the source container has been transported to a port for picking within a predefined period of time.

Also, the central computer system can choose the container with the fewest number of times the container has been transported to a port for picking within the predefined period of time is chosen as the source container.

In a second aspect, the invention concerns a system for rearranging containers in an automated storage and retrieval system comprising a framework structure (100) forming a three-dimensional storage grid structure (104) for storing storage containers (106), where the framework structure (100) forms vertical storage columns (105) each having a horizontal area defined by the size of an access opening (112) of the vertical storage columns (105) and where the framework structure comprises a rail system (108) arranged above the storage columns (105), the rail system comprising a plurality of rails extending in an X-direction and a plurality of rails extending in a Y-direction to form a grid, the rails defining a perimeter of each access opening (112) on top of each storage column (105), the rail system (108) providing available routes in the X-direction or the Y-direction for container handling vehicles (201, 301) handling and transferring the storage containers (106) to and from the storage columns (105), the system comprises; a central computer system for performing evaluations of the distribution of the containers in the grid of the storage and retrieval system, a central computer system in the central computer system for creating rearranging jobs if there are free spaces along at least one of the edges of the grid of the storage and retrieval system and there are not enough free spaces in the non-edge cells of the grid of the storage and retrieval system to maintain normal operations, at least one container handling vehicle for performing the rearranging jobs created by the central computer system.

The rearranging jobs can have a higher priority in the central computer system than ordinary transportation jobs between the grid of the storage and retrieval system and the ports of the storage and retrieval system.

A third aspect the invention can be directed to a computer program product embodied on a non-transitory computer readable medium, the computer program product including instructions that, when executed by a processor, cause the processor to perform the method for rearranging containers in an automated storage and retrieval system as stated in the method claims.

By using the solution presented here the containers will regularly be distributed around the grid in order to make sure that the grid is best prepared for a dig down.

### BRIEF DESCRIPTION OF THE DRAWINGS

Following drawings are appended to facilitate the understanding of the invention. The drawings show embodiments of the invention, which will now be described by way of example only, where:

FIG. 1 is a perspective view of a framework structure of a prior art automated storage and retrieval system.

FIG. 2 is a perspective view of a prior art container handling vehicle having an internally arranged cavity for carrying storage containers therein.

FIG. 3 is a perspective view of a prior art container handling vehicle having a cantilever for carrying storage containers underneath.

FIG. 4 is a perspective view, seen from below, of a prior art container handling vehicle having an internally arranged cavity for carrying storage containers therein.

FIG. 5 is a flow diagram of the process used to distribute the containers evenly around the grid.

FIG. 6 is a side view cut through of a grid before clean-up.

FIG. 7 is a side view cut through of the grid in FIG. 6 after the clean-up.

### DETAILED DESCRIPTION OF THE INVENTION

In the following, embodiments of the invention will be discussed in more detail with reference to the appended drawings. It should be understood, however, that the drawings are not intended to limit the invention to the subject-matter depicted in the drawings.

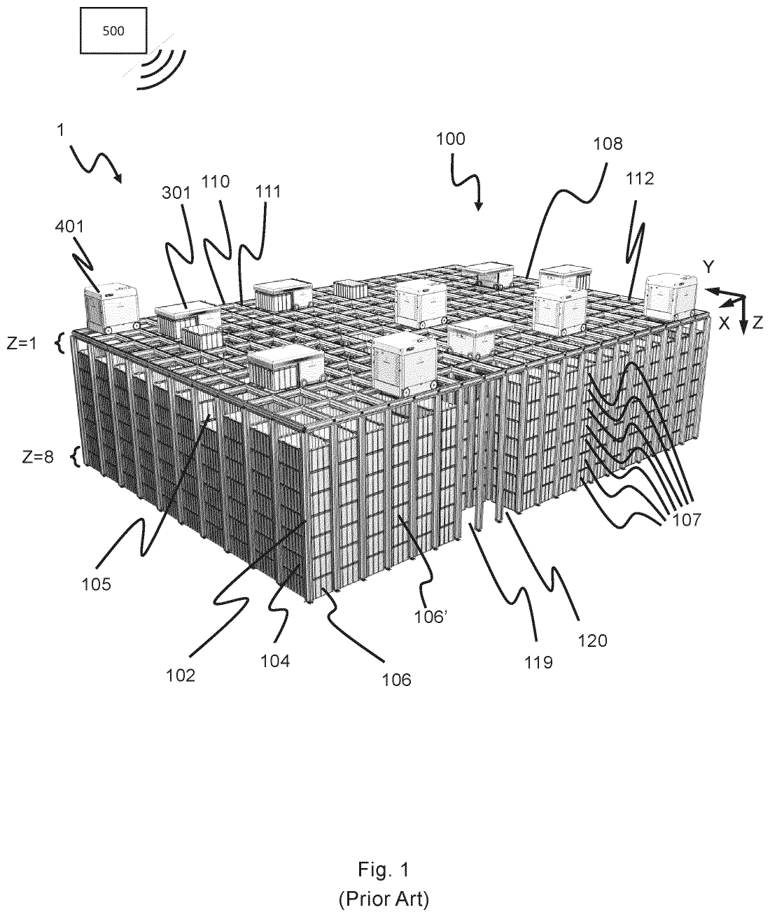

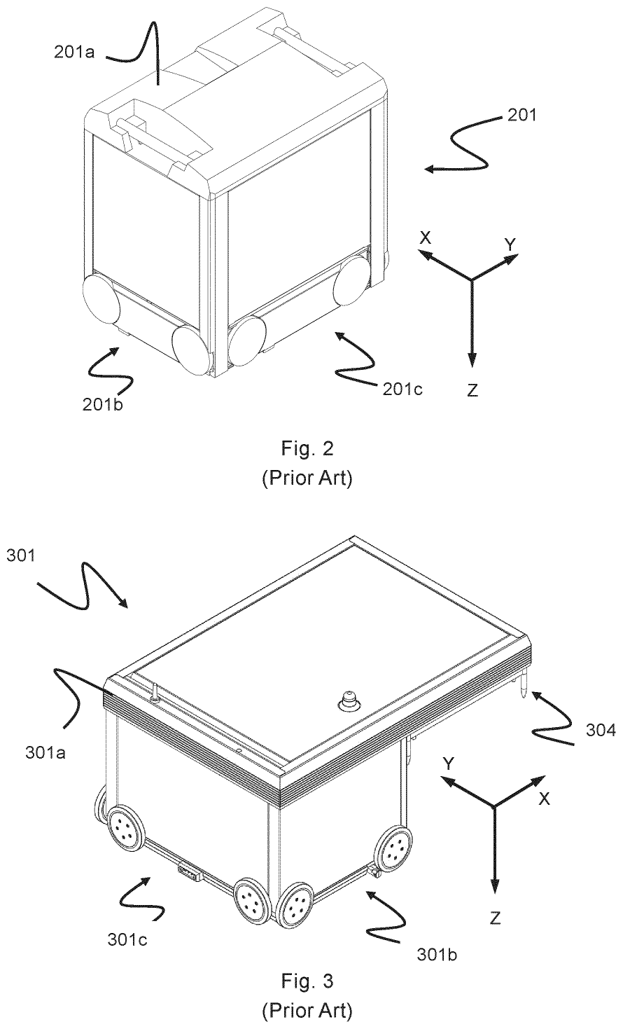

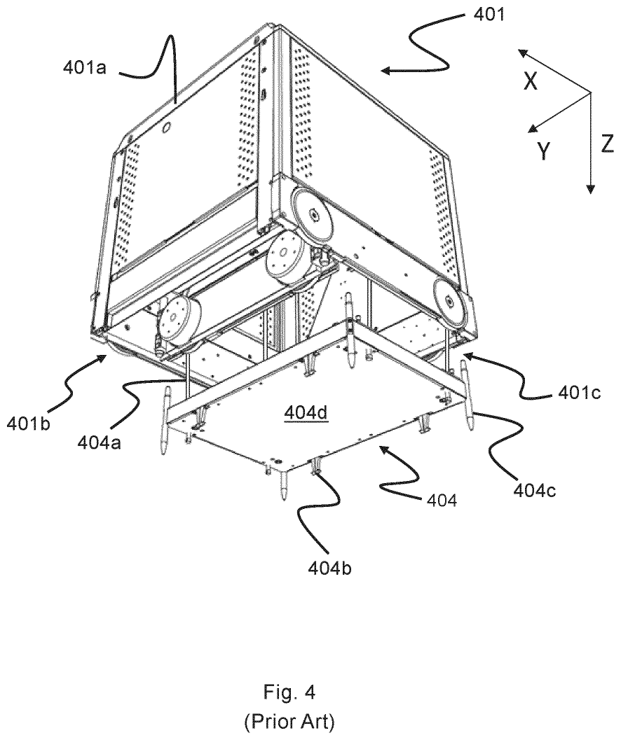

The framework structure 100 of the automated storage and retrieval system 1 is constructed in a similar manner to the prior art framework structure 100 described above in connection with FIGS. 1-3. That is, the framework structure 100 comprises a number of upright members 102, and comprises a first, upper rail system 108 extending in the X direction and Y direction.

The framework structure 100 further comprises storage compartments in the form of storage columns 105 provided between the members 102 wherein storage containers 106 are stackable in stacks 107 within the storage columns 105.

The framework structure 100 can be of any size. In particular it is understood that the framework structure can be considerably wider and/or longer and/or deeper than disclosed in FIG. 1. For example, the framework structure 100 may have a horizontal extent of more than 700×700 columns and a storage depth of more than twelve containers.

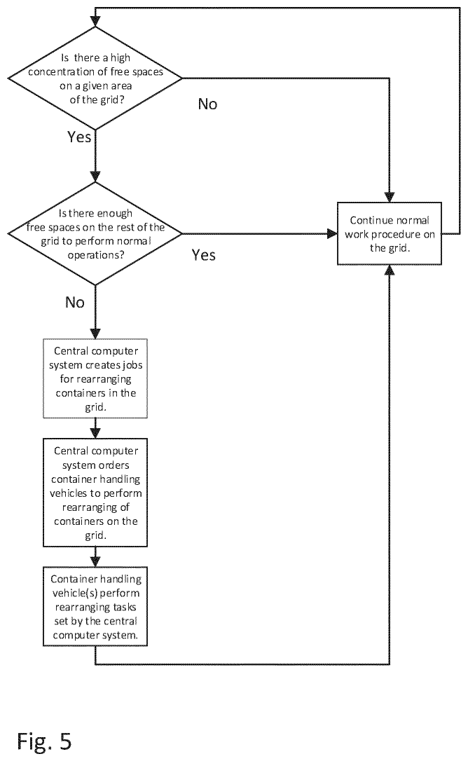

One embodiment of the automated storage and retrieval system according to the invention will now be discussed in more detail with reference to FIGS. 5-7.

FIG. 5 is a flow diagram of an example of the process used to distribute the containers evenly around the grid.

It is not unusual in storage and retrieval systems that free spaces tend to be located around the edges of the storage and retrieval system especially if all the ports are located at one side of the grid. If this is the case, then free spaces will normally be on the opposing side of the storage and retrieval system than the ports.

By free spaces we refer to a column that has at least one container less than the maximum number of containers allowed in the stack in that column. If a column has multiple free spaces, it is then referred to as a deep hole.

The most used containers will end up stacked closest to the ports. This is due to the most used containers will automatically end up on top of a stack close to the port so the free spaces will end up on the area of the grid that has the least activity.

One of the tasks of the central computer system software is to keep the free spaces spread throughout the grid, as these free spaces are used for temporarily storing other containers during digging operations and preparation operations before they are sent to a port. The main way to distributing the free spaces is by placing containers strategically when coming out of a port. However, if all ports or a majority of the ports are on one side of the grid, very few containers will be put on the opposite side of the grid. This typically results in relatively deep holes on the opposite side of the grid to the port or ports.

Edge clean-up refers to a routine performed by the central computer system to fill relatively deep holes, which may be present on the edges of the grid. This is only done if the central computer system finds it absolutely necessary to perform the routine, to avoid doing unnecessary work. Rearranging jobs are created to improve the performance of the storage and retrieval system. For example, rearranging jobs are created if there are not enough free spaces in non-edge cells on the grid to perform normal operations, such as digging from the bottom of a cell. Rearranging jobs can be created when there are not enough target free spaces for containers coming out of a port back to the grid. If any of the above criteria are met, the central computer system searches for the best edge target cell, and the best source container/cell for the job. The best target cells and source cells are found based on the number of available container free spaces in the cell, as well as a score calculated based on the free space in the nearby cells.

An embodiment of the present invention has the following method

Is there a high concentration of free spaces on a given area of the storage and retrieval system? If yes the central computer system make an estimation if there are enough free spaces on the rest of the grid to perform normal operations? If the distribution of the containers are such that the free spaces are not concentrated in one area of the grid the operation of the storage and retrieval system will continue as normal.

If not the central computer system creates jobs for rearranging containers in the storage and retrieval system.

Also, the central computer system orders the container handling vehicles to perform rearranging of containers on the grid.

In an alternative solution the rearranging of containers across the storage and retrieval system is initiated by the number of free cells across a given area of the storage and retrieval system by itself even though there are free cells enough to perform normal operations on the rest of the grid.

In yet another alternative solution of the present invention the rearranging of the containers in the storage and retrieval system is initiated automatically when the activity on the storage and retrieval system is below a certain level. An example of this is when the system is operating on e.g. 50%. This solution initiates the rearranging of the containers in the storage and retrieval system e.g. at night when the activity normally drops.

The continuing normal operations on the grid of the storage and retrieval system after the at least one container handling vehicle has performed the at least one rearranging job.

Normal operations comprises performing a deep dig down for a container and requires the grid to have enough free spaces to place containers returning from a port.

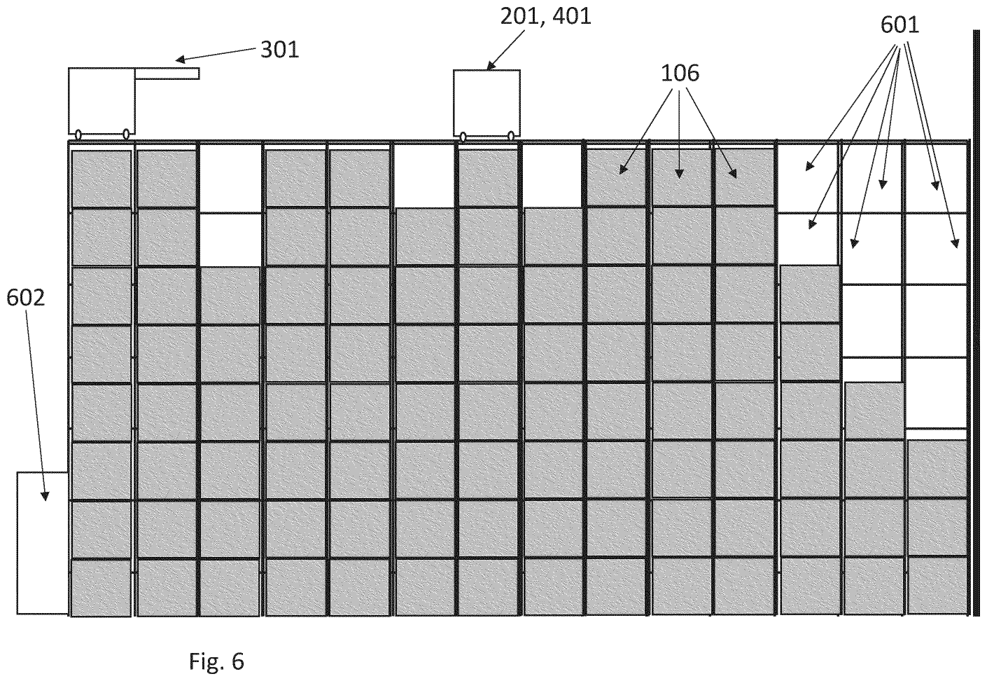

FIG. 6 is a side view cut through of a grid before the rearranging of the containers in a given area the storage and retrieval system. During normal operations of the storage and retrieval system the containers will automatically be stored closest to the ports. If the ports are located at one side of the storage and retrieval system, the containers will automatically be stored closest to the ports. This will then result in a plurality of free cells along the edge of the storage and retrieval system that is the farthest from the side the ports are on.

When there are not enough free cells in the busiest area of the storage and retrieval system, normal operations will be delayed since the container handling vehicles must travel further with the containers in order to find a free space to put the container. Normal operations are considered as transporting containers to and from the ports and performing dig downs. A dig down is when the container handling vehicle has to lift up on or more containers in a column in order to reach a container that is located underneath others in the column. The containers that are stored on top of the container of interest must be moved before the container of interest can be lifted and transported to the port. The longer a container handling vehicle has to travel to find a free space for the containers the longer time the dig down will take, and the efficiency of the storage and retrieval system is reduced.

In order to overcome the problems with an uneven distribution of the free cells the central computer system in the storage and retrieval system creates jobs comprised of finding a source cell that has a container that is to be moved to a target cell that has at least one free space.

The central computer system also performs evaluations of the distribution of the containers in the grid of the storage and retrieval system in order to get an estimate of how the distribution of free spaces is in the grid and if there is a need to rearrange the containers.

The jobs made by the central computer system in order to rearrange the containers in a given area of the storage and retrieval system have a higher priority in the central computer system than ordinary transportation jobs between the grid of the storage and retrieval system and the ports of the storage and retrieval system.

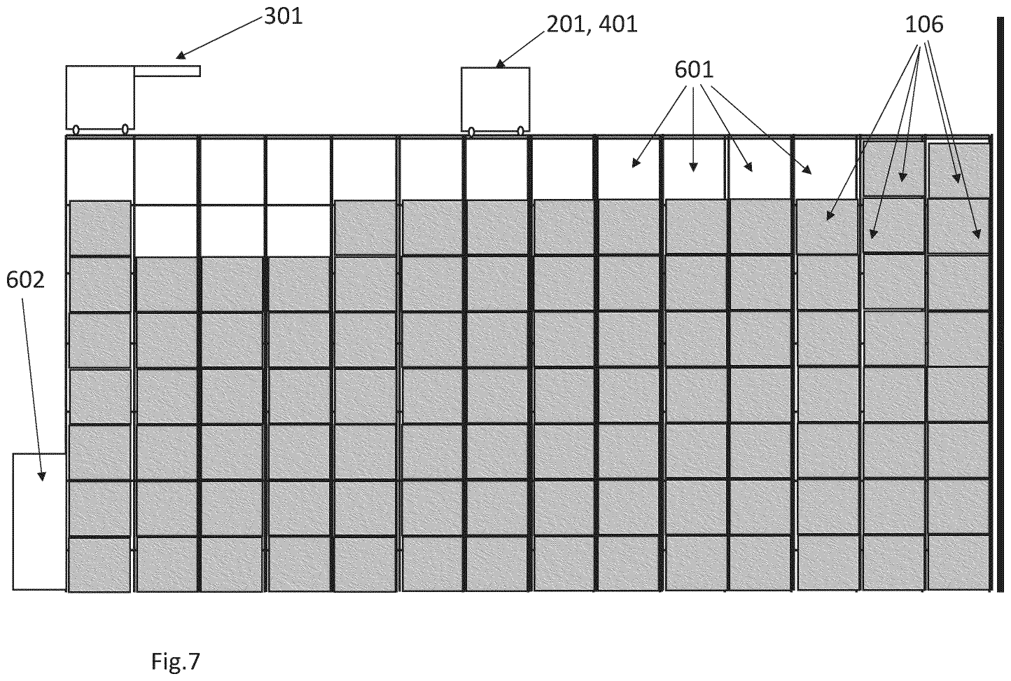

FIG. 7 is a side view cut through of the grid in FIG. 6 after the clean-up, here it is possible to see that the free spaces are distributed evenly throughout the columns.

In the preceding description, various aspects of the delivery vehicle and the automated storage and retrieval system according to the invention have been described with reference to the illustrative embodiment. For purposes of explanation, specific numbers, systems, and configurations were set forth in order to provide a thorough understanding of the system and its workings. However, this description is not intended to be construed in a limiting sense. Various modifications and variations of the illustrative embodiment, as well as other embodiments of the system, which are apparent to persons skilled in the art to which the disclosed subject matter pertains, are deemed to lie within the scope of the present invention.

### LIST OF REFERENCE NUMBERS

### Prior Art (FIGS. 1-4), Present Invention (FIG. 5-7)

1 Prior art automated storage and retrieval system
100 Framework structure
102 Upright members of framework structure
104 Storage grid
105 Storage column
106 Storage container
106′ Particular position of storage container
107 Stack
108 Rail system
110 Parallel rails in first direction (X)
112 Access opening
119 First port column
120 Second port column
201 Prior art container handling vehicle
201a Vehicle body of the container handling vehicle 201
201b Drive means/wheel arrangement/first set of wheels in first direction (X)
201c Drive means/wheel arrangement/second set of wheels in second direction (Y)
301 Prior art cantilever container handling vehicle
301a Vehicle body of the container handling vehicle 301
301b Drive means/first set of wheels in first direction (X)
301c Drive means/second set of wheels in second direction (Y)
304 Gripping device
401 Prior art container handling vehicle
401a Vehicle body of the container handling vehicle 401
401b Drive means/first set of wheels in first direction (X)
401c Drive means/second set of wheels in second direction (Y)
404 Gripping device
404a Lifting band
404b Gripper
404c Guide pin
404d Lifting frame
500 Control system
601 Free cell
602 Port
X First direction
Y Second direction
Z Third direction

1. A method for rearranging storage containers in an automated storage and retrieval system comprising a framework structure forming a three-dimensional storage grid structure for storing the storage containers, where the framework structure forms vertical storage columns each having a horizontal area defined by a size of an access opening of the vertical storage columns and where the framework structure comprises a rail system arranged above the storage columns the rail system comprising a plurality of rails extending in an X-direction and a plurality of rails extending in a Y-direction to form a grid, the rails defining a perimeter of each access opening on top of each storage column the rail system providing available routes in the X-direction or the Y-direction for container handling vehicles handling and transferring the storage containers to and from the storage columns wherein the method comprises:
monitoring a number of free spaces along at least one edge of the grid of the storage and retrieval system using a central computer system to determine if there are enough free spaces in a remainder of cells of the grid of the storage and retrieval system to perform normal operations,
creating one or more rearranging jobs in the central computer system if there are more than a predetermined density of free spaces along at least one of the edges of the grid of the storage and retrieval system and it is determined that the density of free cells is not enough in the remainder of the cells of the grid of the storage and retrieval system to maintain the normal operations,
instructing at least one container handling vehicle to perform the at least one rearranging job, wherein the at least one container handling vehicle transports the storage containers to at least one of the edges of the grid from cells in the remainder of the grid of the storage and retrieval system.

2. The method according to claim 1 further comprising continuing the normal operations on the grid of the storage and retrieval system after the at least one container handling vehicle has performed the at least one rearranging job.

3. The method according to claim 2, wherein the normal operation comprises performing a deep dig down for one of the storage containers.

4. The method according to claim 1, wherein a normal operation requires the grid to have enough free spaces to place at least one of the storage containers returning from a port.

5. The method according to claim 1, wherein the central computer system searches for a target cell along the edges of the grid.

6. The method according to claim 5, wherein the central computer system searches for a source cell from the remainder of the grid for each rearranging job, and optionally a source container from the source cell.

7. The method according to claim 6, wherein the central computer system chooses the target cell and the source cell based on the number of free spaces and/or available containers in the target cells and the source cells.

8. The method according to claim 5, wherein the central computer system chooses a cell along at least one of the edges of the grid of the storage and retrieval system that has a largest number of free spaces to be the target cell.

9. The method according to claim 5, wherein the central computer system chooses a cell from the remainder of the cells that has a fewest free spaces to be a source cell.

10. The method according to claim 6, wherein numbers of free spaces in neighbouring cells are taken into account when picking the target cell and the source cell.

11. The method according to claim 5, wherein numbers of free spaces in neighbouring cells are taken into account when picking a source container.

12. The method according to claim 8, wherein the central computer system chooses a cell to be the target cell if that target cell and its neighbouring cells have the largest numbers of free spaces in a given area of the grid.

13. The method according to claim 8, wherein the central computer system choses a second cell to be a source cell.

14. The method according to claim 13, wherein the central computer system choses the second cell to be the source cell if that source cell and its neighbouring cells have a fewest number of free spaces in a given area of the grid.

15. The method according to claim 4, wherein the central computer system chooses a container to be a source container based upon a number of times the source container has been transported to a port for picking within a predefined period of time.

16. The method according to claim 15, wherein the central computer system chooses the container with a fewest number of times the container has been transported to the port for picking within the predefined period of time is chosen as the source container.

17. A system for rearranging containers in an automated storage and retrieval system comprising a framework structure forming a three-dimensional storage grid structure for storing storage containers, where the framework structure forms vertical storage columns each having a horizontal area defined by a size of an access opening of the vertical storage columns and where the framework structure comprises a rail system arranged above the storage columns the rail system comprising a plurality of rails extending in an X-direction and a plurality of rails extending in a Y-direction to form a grid, the rails defining a perimeter of each access opening on top of each storage column the rail system providing available routes in the X-direction or the Y-direction for container handling vehicles handling and transferring the storage containers to and from the storage columns wherein the system comprises:
a central computer system for performing evaluations of a distribution of the containers in the grid of the storage and retrieval system,
creating rearranging jobs if there are free spaces along at least one edge of the grid of the storage and retrieval system and there are not enough free spaces in non-edge cells of the grid of the storage and retrieval system to maintain normal operations,
at least one container handling vehicle for performing the rearranging jobs created by the Central computer system.

18. The system according to claim 17, wherein the rearranging jobs have a higher priority in the central computer system than ordinary transportation jobs between the grid of the storage and retrieval system and ports of the storage and retrieval system.

19. A computer program product embodied on a non-transitory computer readable medium, the computer program product including instructions that, when executed by a processor, cause the processor to perform the method for rearranging containers in an automated storage and retrieval system as stated in claim 1.
